(19) United States
(12) Patent Application Publication
(10) Pub. No.: US 2006/0143417 A1
(43) Pub. Date: Jun. 29, 2006

(54) Mechanism for restricting access of critical disk blocks

(76) Inventors: David Poisner, Folsom, CA (US); Steve Grobman, Edl Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,858

(22) Filed: Dec. 23, 2004

(51) Int. Cl. G06F 12/14

(52) U.S. Cl. 711/164

(57) ABSTRACT

According to one embodiment, an apparatus is presented. The apparatus includes a storage device, a hypervisor, a plurality of partitions mapped by the hypervisor, and a key created by the hypervisor to prevent one of the plurality of partitions from accessing a protected block range of the storage device. In one embodiment, a disk controller is coupled to the plurality of partitions to interface with the storage device, and the disk controller is programmed with the key in order to restrict access to the protected block range.

### FIELD OF THE INVENTION

The present embodiments of the invention relate generally to the field of computer architecture and, more specifically, relate to methods and systems to protect critical sections of a disk from access within a logically partitioned data processing system.

### BACKGROUND

Emerging systems architectures leverage hypervisors or hard partitions to host multiple operating systems on a single platform. Hypervisors are a class of virtual machine monitors (VMM), which implement the foundation architecture to launch virtual machines. In other words, hypervisors creates a number of different execution environments on a single computer, each execution environment emulating a host computer.

One system architecture implementation using hypervisors and/or hard partitions directly maps a disk input/output (I/O) controller to a specific partition, usually the primary user partition, in order to give the platform the highest I/O performance. It is advantageous to directly map the disk I/O controller directly to a partition because it increases system performance. This is because emulating the disk I/O controller in the hypervisor involves running code that may create a performance loss for the system.

However, current platform architectures lack the ability to protect specific sections of the disk assigned to a first partition if the disk I/O controller is directly mapped to a second partition because the device drivers and/or kernel mode software of the second partition can perform any legal command to the I/O controller. These commands may include sending commands that would manipulate regions of the disk that are to be used only by the first partition, and may thus be valuable to protect. It is valuable to be able to protect sections of the disk such that they cannot be overwritten by the other partition(s).

For example, in a system that maps the I/O controller to a primary guest operating system (OS) partition, there are areas of the disk that are valuable to protect. Example key areas to protect from the primary guest partition include: the boot sector, the hypervisor code, initial images for other partitions that may be stored to the disk.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of one embodiment of a computer system;

FIG. 2 illustrates a block diagram of one embodiment of a virtual machine system;

FIG. 3 depicts of a flow diagram of one embodiment of a method to access a key-protected block range of a disk;

FIG. 4 illustrates a block diagram of one embodiment of logical block addressed ranges in a disk; and

FIG. 5 illustrates a block diagram of one embodiment of a table storing block ranges and associated keys.

### DETAILED DESCRIPTION

A method and apparatus to restrict access of critical disk blocks is presented. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the present invention.

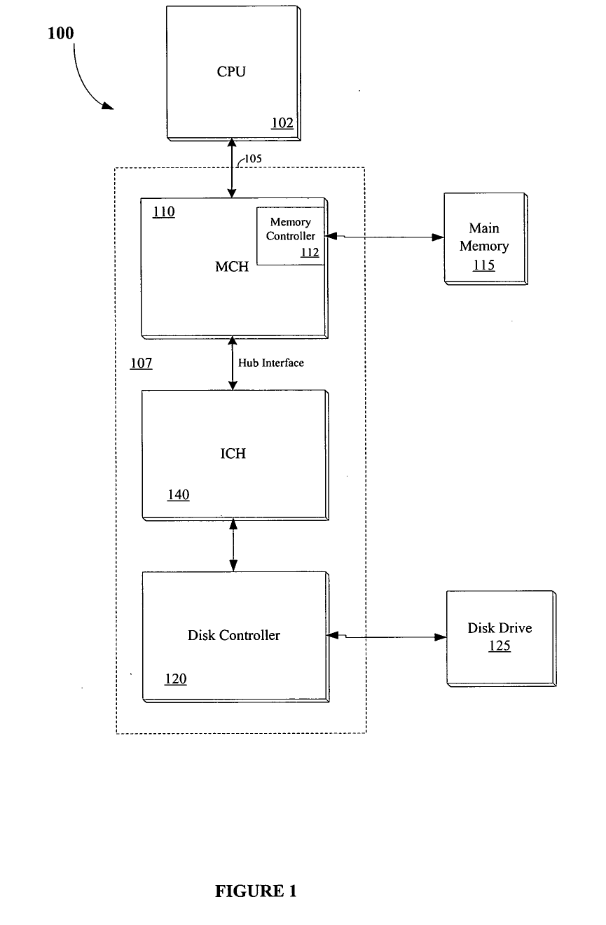

FIG. 1 is a block diagram of one embodiment of a computer system 100 to implement the apparatus and method of the embodiments of the present invention. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types.

Additional devices may also be coupled to bus 105, such as multiple CPUs and/or multiple system memories.

Chipset 107 also includes an input/output control hub (ICH) 140 coupled to MCH 110 via a hub interface. ICH 140 provides an interface to input/output (I/O) devices within computer system 100. For instance, ICH 140 may be coupled to a Peripheral Component Interconnect bus adhering to a Specification Revision 2.1 bus developed by the PCI Special Interest Group of Portland, Oreg. CPU 102, the components of chipset 107 and memory 115 all include I/O buffers to facilitate the transmitting and receiving data.

Chipset 107 further includes disk controller 120 coupled to ICH 140 via the hub interface. Disk controller 120 provides an interface for and control over disk drive 125. In one embodiment, disk controller 120 is a Serial Advanced Technology Attachment (SATA) interface controller. Disk drive 125 stores data, such a programs and system files. In one embodiment, disk drive 125 includes a hard disk storage mechanism; however disk drive 125 may be implemented using other storage devices, such as a floppy drive or a CD-ROM drive. In some embodiments, the disk controller 120 may be part of the ICH 140.

Embodiments of the present invention may refer to a storage device. Such storage device may include main memory 115 or disk drive 125. However, the storage device is not limited to those storage means. The storage device may also include flash memory, RAM, or ROM, for example. In general, storage device refers to any storage mechanism that stores data, programs, and/or system files of computer system.

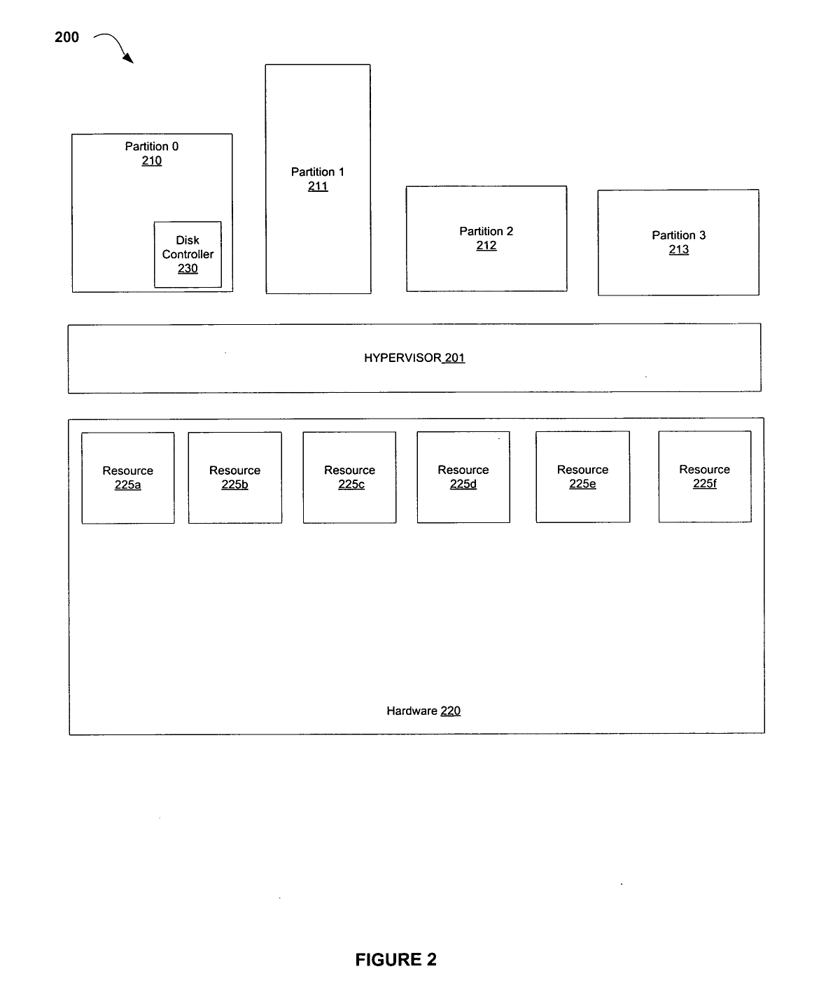

FIG. 2 is a block diagram illustrating a conceptual depiction of a virtual machine system 200 according to one embodiment of the present invention. System 200 includes logical partitions 210-213, a hypervisor 201, and system resources 225a through 225f as part of system hardware 220.

Hypervisor 201 is typically implemented as computer executable instructions (software) stored on a computer readable medium such as main memory, cache memory, disk storage, ROM storage, flash memory, and the like. Hypervisor 201 may also me implemented as firmware. Firmware is “hard software” stored in a memory chip that holds its contents without electrical power, such as, for example, read-only memory (ROM), programmable ROM (PROM), erasable programmable ROM (EPROM), electrically erasable programmable ROM (EEPROM), and non-volatile random access memory (non-volatile RAM).

Hypervisor 201 is suitable for partitioning a data processing system into independent and logically distinct partitions. Hypervisor 201 creates and enforces the partitioning of the logically partitioned platform.

Hypervisor 201, according to one embodiment of the present invention, maps logical partitions and their corresponding logical resources to the system's physical resources 225a through 225f (referred to collectively or generically as 220). System resources 225a through 225f are part of system hardware 220, and may include but are not limited to resources such as processors, storage, memory, and input/output controls.

Disk controller 230 is illustrated as being directly mapped to partition 210. Such a configuration reduces the performance hit a system takes as compared to when the disk controller is emulated in the hypervisor software. Partition 210 has true ownership of disk controller 230. However, in prior architectures, such a configuration lacks the ability to protect specific sections of the disk because the device drivers and/or kernel mode software in partition 210 can execute any legal command to the disk controller. The areas of the disk allocated to the other partitions (e.g., partitions 211, 212, and 213) could be accessed or modified by partition 210.

Embodiments of the present invention include modifications to a disk controller physically mapped to a partition. The modifications allow the disk controller to be programmed so that it can take advantage of the load sequence of a hypervisor architecture system, such that only the hypervisor has access (read and/or write) to specific regions of the disk.

The embodiments described herein are useful in hypervisor style systems, as well as in systems employing a boot loader that protects critical sections of disk from a classic operating system architecture. For convenience, the details described are in terms of disk transactions that utilize a logical block addressing (LBA) scheme, however it should be noted that the capabilities apply to classical disk geometry transactions as well.

One embodiment of the present invention include the hypervisor 201 programming into the disk controller 230 specific block ranges of a disk for write and/or read protection. Upon programming the range, an agreed upon “key” will be supplied to the disk controller that is required for any future protected operations to the specified range. In some embodiments, the key is a random number, which may be generated by the computer system or obtained through other means.

The key is stored in memory that is accessible only to the hypervisor. When any other partition attempts to directly access the protected range using the disk controller, it has a very low probability of being able to access protected sectors because it would have to guess the key. The larger the size of the key, the smaller the chance of an unauthorized access by guessing the key.

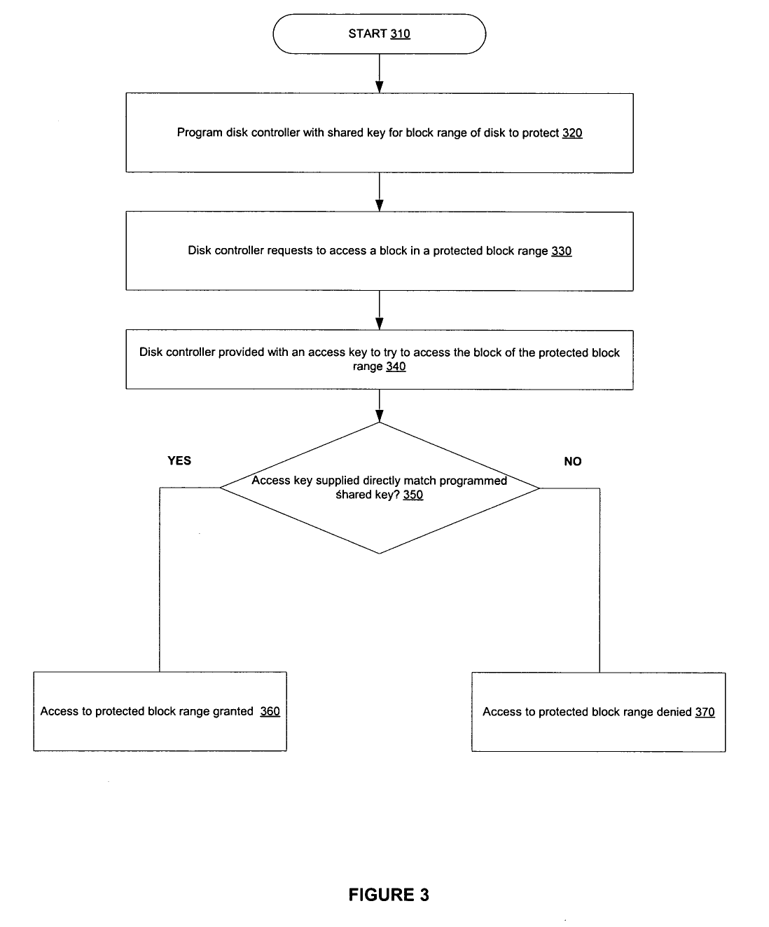

FIG. 3 is a flow diagram illustrating a method of accessing a key-protected block range of a disk. The method begins at start block 310. At processing block 320, the hypervisor programs the disk controller with the key for the protected block range of the disk. Then, at processing block 330, a partition attempts to use the disk controller to access a block of the protected block range. At processing block 340, the disk controller is provided with an access key by the partition attempting to access the block of the protected block range.

At decision block 350, the disk controller determines whether the access key supplied for accessing the block of the protected block range matches the programmed shared key. If there is a direct match, then the process continues to processing block 360 where the disk controller grants access to the block of the protected block range. If the supplied access key and the programmed shared key do not match at decision block 350, then the process continues to processing block 370 where the disk controller denies access to the block of the protected block range.

In some embodiments, the key can be discarded by software. This effectively locks the protected region on the disk until the next system boot. Such an embodiment might be useful where no further operations will be performed until the platform is cycled.

In another embodiment, the disk controller may impose defensive measures against “brute force” attacks, including guessing the key. One defensive measure includes disabling all access to the protected region of the disk. Another defensive measure includes halting the system after ‘N’ invalid attempts to access the protected region while supplying the incorrect key. The number of attempts, ‘N’, before halting the system is implementation specific.

In another embodiment, normal attempts to access protected portions of the disk (typically by the primary partition) may cause the disk controller to generate a system interrupt that can be serviced by the hypervisor. As the hypervisor possesses the programmed key, it can determine if it is appropriate to perform the desired operation. The hypervisor can then send a request to the disk controller, including the programmed key, to allow the access.

Another embodiment of the present invention is based on the fact that LBA capabilities that exist today are based on a large number, typically 48 bits, for the block address. In this embodiment, the key programmed into the disk controller, as described above, can instead be used in the embedded block address itself. The key is derived by choosing a large number that is greater than the number of actual physical blocks on the disk. For all normal operations accessing a non-protected block, the standard block number is passed to the controller. However, in cases where a protected block is accessed by privileged software, the block number with the offset of the key LBA is passed.

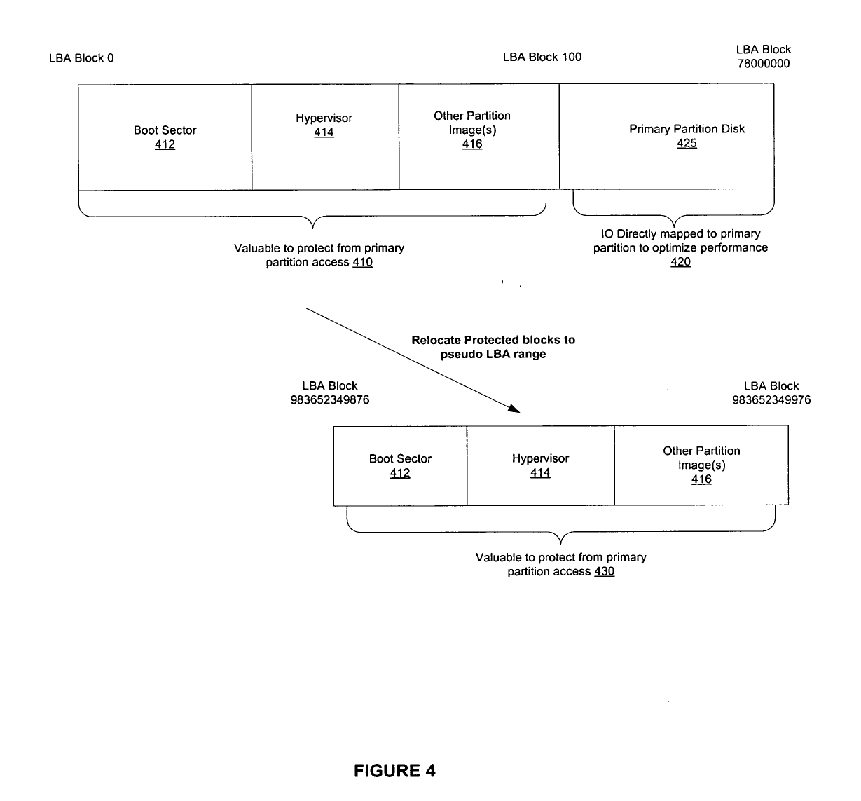

FIG. 4 is a block diagram illustrating portions of a disk with a LBA scheme. The physical block locations of boot sector 412, hypervisor 414, other partition images 416, and primary partition disk 425 are shown as being located in LBA blocks 0 through LBA blocks 78000000. Block range 410 includes the boot sector 412, hypervisor 414, and other partition images 416, as areas of the disk that are valuable to protect from the primary partition 425.

In one embodiment of the invention, the protected portions of the disk 410 are shown as being relocated to a pseudo LBA range 430 using a key. In order to access these areas of the disk, the actual address of the desired block would have to be offset by the key. As shown in FIG. 4, the key is the number 983652349876. If a partition tried to access the boot sector in this example, then it would have to provide the pseudo address 983652349876, which is the LBA block address 0 plus the offset of the key, 983652349876. One skilled in the art will appreciate that they key can be any random number, and that various areas of the disk can be selected for protection.

In one embodiment, the disk controller can perform the defensive measures mentioned above to avoid “brute force” attacks. Furthermore, in other embodiments, other defensive measures may be employed, such as locking out the protected segments of the disk if ‘N’ operations are performed outside the range of standard LBA or the relocated protected segment.

In lieu of programming the disk controller, another embodiment of the present invention leverages a table that indicates what ranges of disk blocks are “protected” and what the appropriate keys are to read and/or write to the blocks. In some embodiments, the table may be located in main memory or SRAM local to the disk controller.

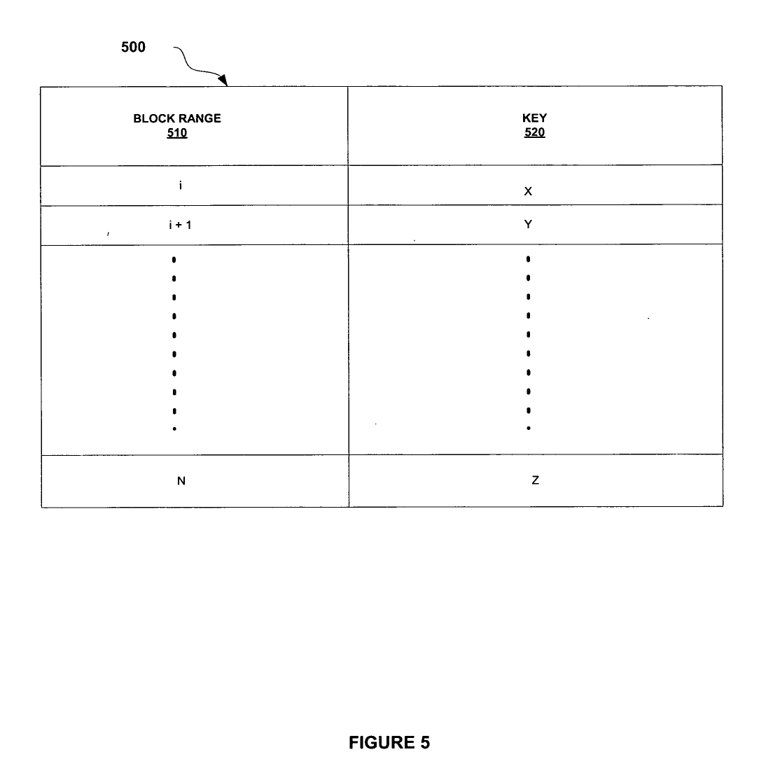

FIG. 5 illustrates an exemplary embodiment of a table 500 to store various protected sub-ranges of a disk 510 and their corresponding keys 520. In one embodiment, the number of block ranges 510 to be protected is implementation specific. As illustrated in FIG. 5, block ranges 510 ‘i’ through ‘N’ are listed as protected with a corresponding key 520. The keys 520 ‘X’, ‘Y’, and ‘Z’ are random numbers generated by the processor. Table 500 can be located in various memory locations, such as main memory or other local memory in a computer system.

This embodiment is flexible in how the drive can be protected. It also may provide a higher level of security as different sub-ranges in the disk have a different key to access it, versus only one key for all of the sub-ranges. However, if the table is in main memory, the memory may be subject to various attacks, such as snooping attacks. In one embodiment, protecting against snooping attacks to the table in main memory could be done using known methods to those skilled in the art. Such methods include memory protection schemes, or architectures that enable physical address and device translation for all components in the platform.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

1. An apparatus, comprising:
a storage device;
a hypervisor;
a plurality of partitions mapped by the hypervisor; and
a key created by the hypervisor to prevent one or more of the plurality of partitions from read and write access to a protected block range of the storage device.

2. The apparatus of claim 1, wherein the storage device is at least one of a hard disk, a floppy disk, a CD-ROM disk, flash memory, and RAM.

3. The apparatus of claim 1, further comprising a disk controller coupled to the plurality of partitions to interface with the storage device, the disk controller programmed with the key to restrict access to the protected block range.

4. The apparatus of claim 3, wherein to access the protected block range the key is provided to the disk controller.

5. The apparatus of claim 1, wherein the key offsets an address of the protected block range to prevent unauthorized access to the protect block range.

6. The apparatus of claim 5, wherein to access the protected block range an address of the protected block range plus the offset of the key is provided.

7. The apparatus of claim 5, wherein the address of the protected block range is part of a logical block addressing (LBA) scheme.

8. The apparatus of claim 1, wherein the key is one of a plurality of keys assigned to a plurality of protected block sub-ranges of the protected block range, the plurality of keys and plurality of protected block sub-ranges stored in a table in memory.

9. The apparatus of claim 1, wherein access to the protected block range is disabled after a predetermined number of invalid attempts to access the range with an incorrect key.

10. The apparatus of claim 1, wherein a system interrupt to be serviced by the hypervisor is generated after an invalid attempt to access the protected block range with an incorrect key.

11. A method, comprising:
creating a first key to protect a protected block range of a disk;
detecting an attempt to access a block of the protected block range through a disk controller by providing a second key; and
denying access to the protected block range if the second key does not match the first key.

12. The method of claim 11, further comprising programming the disk controller with the first key to prevent unauthorized access to the protected block range of the disk.

13. The method of claim 11, further comprising granting access by the disk controller if the first key matches the second key.

14. The method of claim 11, further comprising:
offsetting the address of the protected block range by the first key; and
granting access by the disk controller if an address provided to access the protected block range matches the address of the protected block range plus the offset of the first key.

15. The method of claim 11, further comprising disabling access to the protected block range by the disk controller after a predetermined number of invalid attempts to access the range with an incorrect key.

16. A system, comprising:
a processor;
a chip coupled to the processor;
a storage device coupled to the chip;
a plurality of partitions coupled to the processor mapped by a hypervisor; and
a key created by the hypervisor to prevent one or more of the plurality of partitions from read and write access to a protected block range of the storage device.

17. The system of claim 16, wherein the storage device is at least one of a hard disk, a floppy disk, a CD-ROM disk, flash memory, and RAM.

18. The system of claim 16, further comprising a disk controller mapped to one of the plurality of partitions, the disk controller programmed with the key to restrict access to the protected block range.

19. The system of claim 18, wherein to access the protected block range the key is provided to the disk controller.

20. The system of claim 16, wherein the key offsets an address of the protected block range to prevent unauthorized access to the protect block range.

21. The system of claim 16, wherein the key is one of a plurality of keys assigned to a plurality of protected block sub-ranges of the protected block range, the plurality of keys and plurality of protected block sub-ranges stored in a table in memory.

22. The system of claim 16, wherein access to the protected block range is disabled after a predetermined number of invalid attempts to access the range with an incorrect key.

23. An article of manufacture comprising:
a machine-accessible medium including data that, when accessed by a machine, cause the machine to perform operations comprising, creating a first key to protect a protected block range of a disk;
detecting an attempt to access a block of the protected block range through a disk controller by providing a second key; and
denying access to the protected block range if the second key does not match the first key.

24. The article of manufacture of claim 23, wherein the machine-accessible medium further includes data, when accessed, results in the machine performing operations comprising, programming the disk controller with the first key to prevent unauthorized access to the protected block range of the disk.

25. The article of manufacture of claim 23, wherein the machine-accessible medium further includes data, when accessed, results in the machine performing operations comprising:
offsetting the address of the protected block range by the first key; and
granting access by the disk controller if an address provided to access the protected block range matches the address of the protected block range plus the offset of the first key.
